(19) United States
(12) Patent Application Publication
(10) Pub. No.: US 2011/0110113 A1
(43) Pub. Date: May 12, 2011

(54) CONTROL DEVICE OF A HEADLAMP'S HIGH AND LOW BEAM

(76) Inventor: Kwan-Ten HUNG, Tainan City (TW)

(21) Appl. No.: 12/616,137

(22) Filed: Nov. 10, 2009

(51) Int. Cl. B60Q 1/00

(52) U.S. Cl. 362/539

(57) ABSTRACT

A control device of a headlamp's high and low beam includes a lamp base, two drivers and two light shields combined together. The two drivers are respectively installed at two sides of the lamp base, respectively having a driving shaft. The two light shields are respectively assembled on the two drivers and under the front side of the lamp base, having their opposite outer sides respectively bored with a through hole for the driving shaft to be inserted therethrough and their opposite inner sides superposed on each other. The two drivers drive the two light shields to operate for controlling a light projecting range of the headlamp and carrying out change-over of high and low beam of the head lamp.

### BACKGROUND OF THE INVENTION

1. Field of the Invention

This invention relates to a control device of a headlamp's high and low beam, particularly to one provided with drivers to drive two light shields to operate for controlling a light projecting range of an automobile headlamp, able to attain change-over of high and low beam of an automobile headlamp.

2. Description of the Prior Art

Generally, an automobile is provided with a change-over device for controlling a headlamp's high and low beam, which is carried out by turning a whole headlamp base to different angles. However, the conventional way of change-over of a headlamp's high and low beam by turning the angles of the lamp base is likely to cause damage to electric wires when the lamp base is turned around and produces friction.

### SUMMARY OF THE INVENTION

The objective of this invention is to offer a control device of a headlamp's high and low beam, needless to turn the lamp base, and able to control a light projecting range of the headlamp and achieve effect of change-over of a headlamp's high and low beam.

The control device in the present invention includes a lamp base, two drivers and two light shields combined together. The lamp base has its periphery formed with a projecting edge and its interior provided with an arc-shaped reflecting surface and a lamp. The two drivers are oppositely installed at two outer sides of the lamp base and respectively disposed with a driving shaft. The two light shields are respectively assembled on the two drivers, having their opposite outer sides respectively bored with a through hole for the driving shaft to be inserted therethrough. The two light shields are positioned under the front side of the lamp base and have their opposite inner sides superposed on each other.

### BRIEF DESCRIPTION OF DRAWINGS

This invention will be better understood by referring to the accompanying drawings, wherein:

FIG. 1 is an exploded perspective view of a control device of a headlamp's high and low beam in the present invention;

FIG. 2 is a perspective view of the control device of a headlamp's high and low beam in the present invention;

FIG. 3 is a side cross-sectional view of the control device of a headlamp's high and low beam in the present invention, showing light reflection of low beam;

FIG. 4 is a cross-sectional view of the control device of a headlamp's high and low beam in the present invention;

FIG. 5 is a side cross-sectional view of the control device of a headlamp's high and low beam in the present invention, showing light reflection of high beam; and

FIG. 6 is a cross-sectional view of the control device of a headlamp's high and low beam in the present invention, illustrating lighting of high beam.

### DETAILED DESCRIPTION OF THE PREFERRED EMBODIMENT

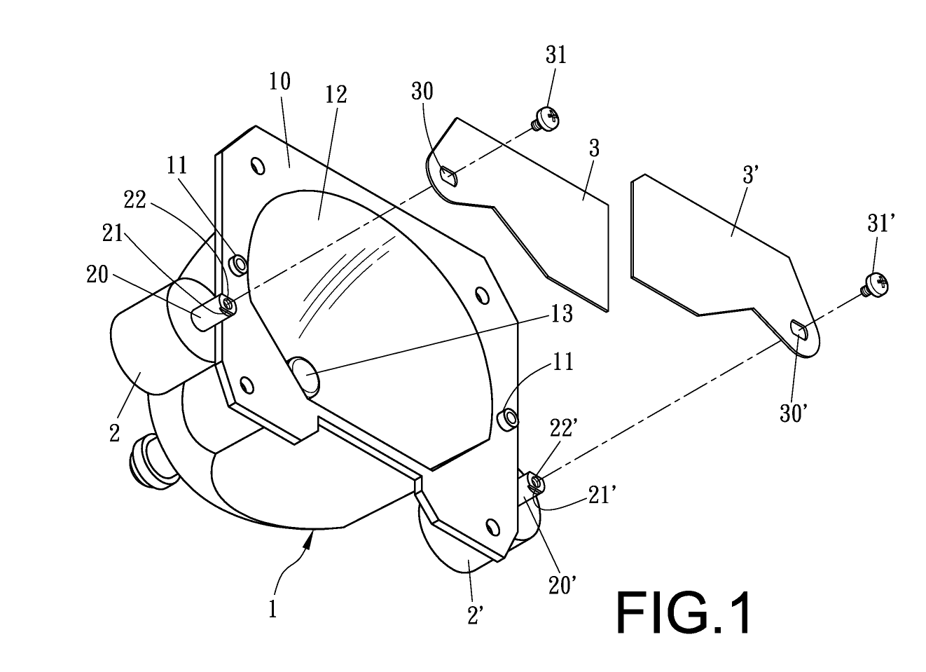

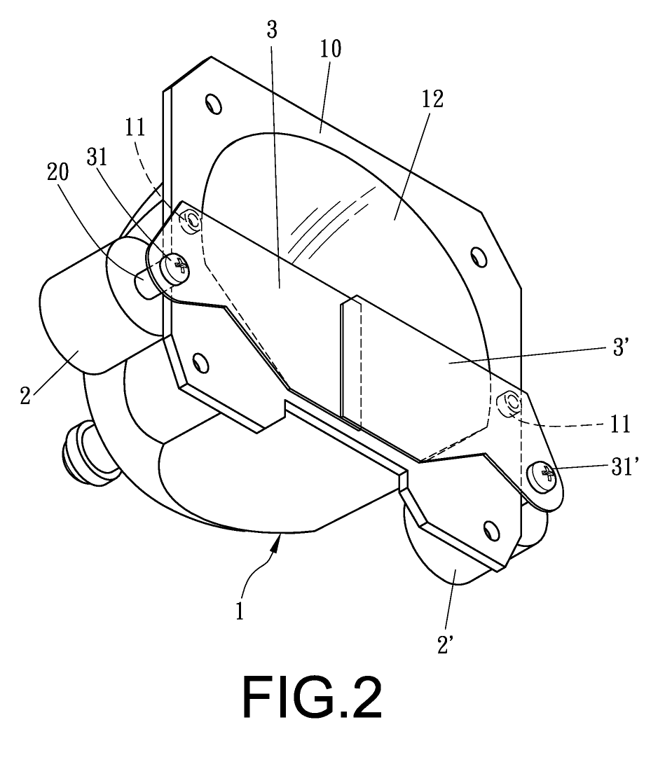

A preferred embodiment of a control device of a headlamp's high and low beam in the present invention, as shown in FIGS. 1, 2 and 3, includes a lamp base 1, two drivers 2, 2′ and two light shields 3, 3′ as main components combined together.

The lamp base 1 has its periphery formed with a projecting edge 10 provided thereon with two projecting bars 11 opposite to each other and its interior provided with an arcuate reflecting surface 12 and a lamp 13.

The two drivers 2, 2′ are oppositely installed at the outer side of the lamp base 1 and respectively disposed with a driving shaft 20, 20′ having an outer end oppositely provided with a tangent plane 21, 21′ and a top end bored with a threaded hole 22, 22′.

The two light shields 3, 3′ are respectively assembled on the two drivers 2, 2′, respectively and oppositely having an outer side bored with a through hole 30, 30′ having a same shape as the outer end of the driving shaft 20, 20′. Two fastening elements 31, 31′ are respectively inserted through the two through holes 30, 30′ and threadably engaged with the threaded holes 22, 22′ of the two drivers 2, 2′. The two light shields 3, 3′ are positioned under the front side of the lamp base 1, having their opposite inner sides superposed on each other.

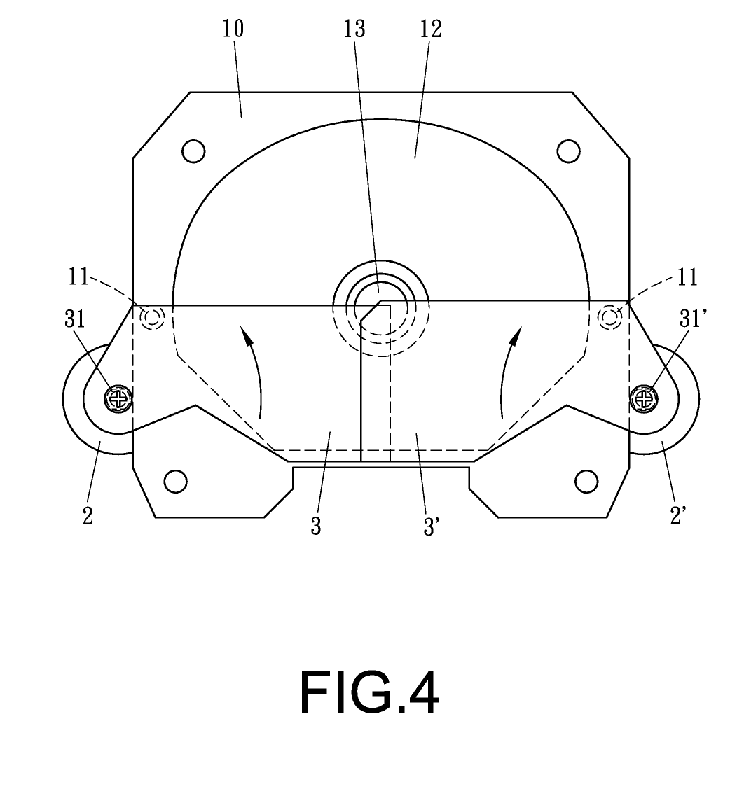

In assembling, referring to FIGS. 1 to 4, the two drivers 2, 2′ are respectively fixed at the opposite outer sides of the lamp base 1, having the driving shaft 20, 20′ respectively protruding out of the opposite sides of the projecting edge 10 of the lamp base 1. Then, the two light shields 3, 3′ are respectively assembled on the two drivers 2, 2′, letting the two driving shafts 20, 20′ respectively inserted through the through hole 30, 31′ of the two light shields 3, 3′. Subsequently, the two fastening elements 31, 31′ are respectively inserted through the through holes 30, 30′ of the two light shields 3, 3′ and threadably secured in the threaded hole 22, 22′ of the two drivers 2, 2′ and then have the opposite inner sides of the two light shields 3, 3′ superposed on each other. At this time, the rear sides of the two light shields 3, 3′ are respectively supported in position by the two projecting bars 11 to let the two light shields 3, 3′ steadily positioned under the front side of the lamp base 1, thus finishing assembly of the control device of a headlamp's high and low beam.

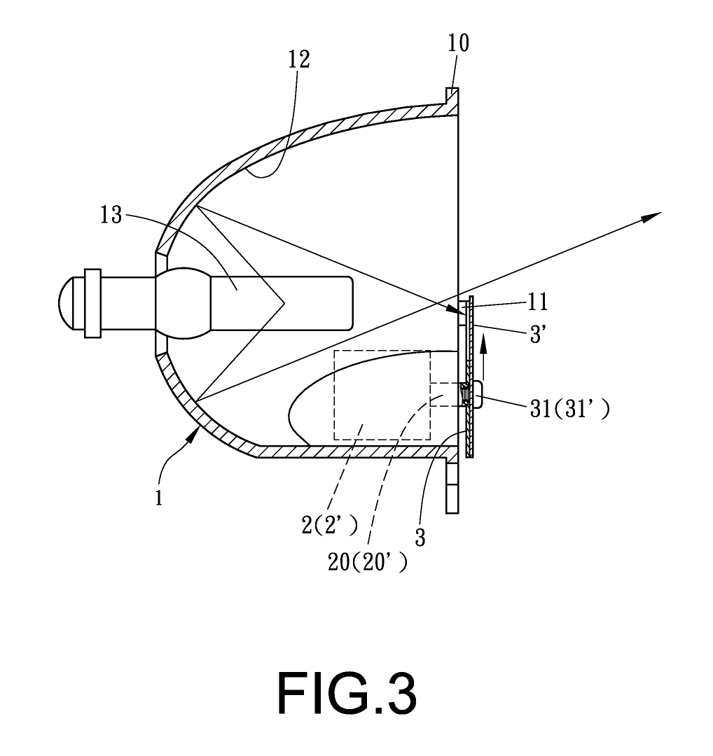

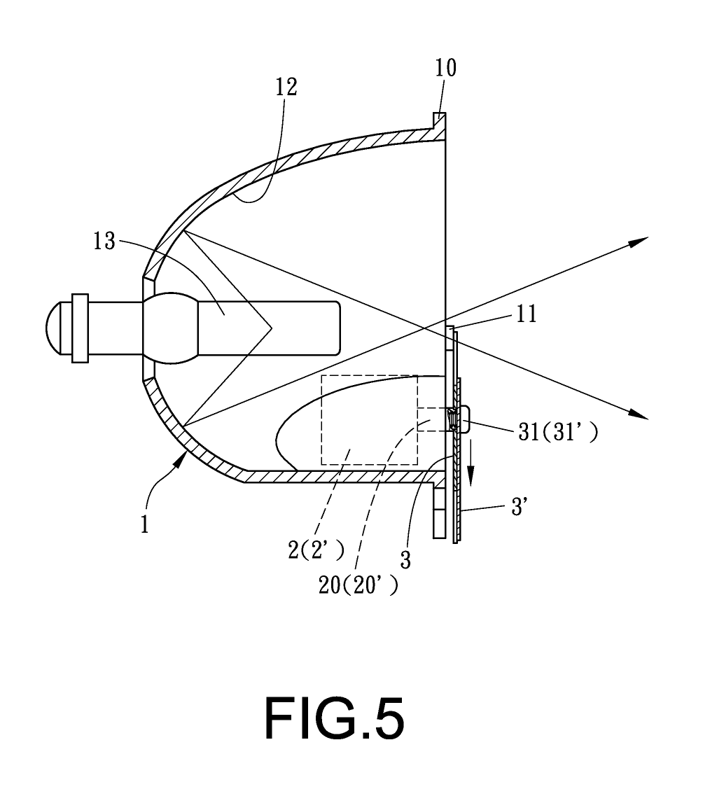

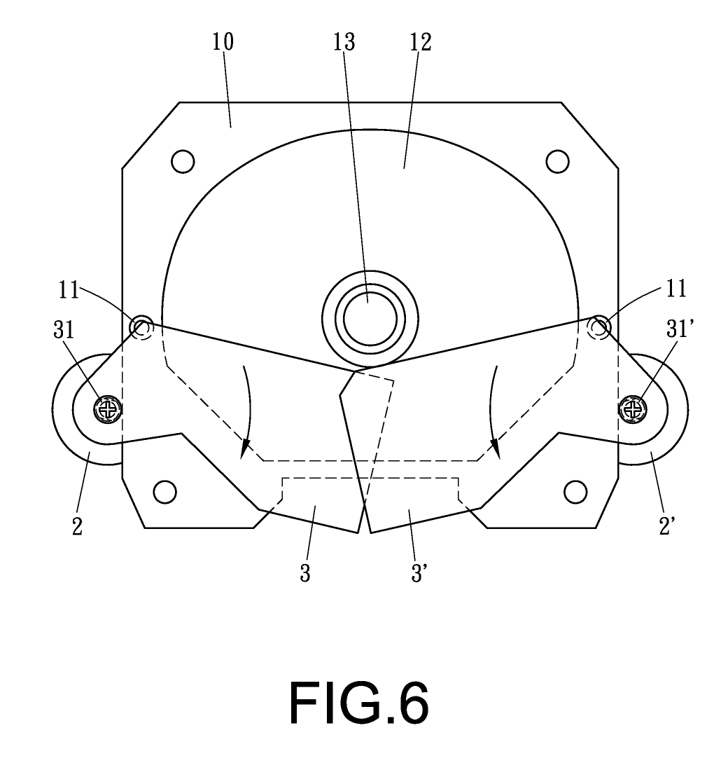

In using and operating, referring to FIGS. 3 to 6, to have the headlamp giving out light of high beam, start the two drivers 2, 2′ to operate by the power source of an automobile and the driving shafts 20, 20′ of the two drivers 2, 2′ will respectively drive the two light shields 3, 3′ to turn respectively with the driving shaft 20, 20′ serving as a pivot, letting the superposed portions of the two light shields 3, 3′ turn and shift downward, as shown in FIG. 6. Thus, light emitted by the lamp 13 in the lamp base 1 and reflected by the reflecting surface 12 will not be obstructed by the two light shields 3, 3′ and hence the light can be projected within a range of a comparatively large angle, as shown in FIG. 5.

On the contrary, to have the head lamp giving out light of low beam, start the drivers 2, 2′ to operate reversely and the driving shaft 20, 20′ of the two drivers 2, 2′ will respectively drive the two light shields 3, 3′ to turn reversely with the driving shaft 20, 20′ respectively acting as a pivot, letting the mutually superposed portions and the opposite sides of the two light shields 3, 3′ turn upward and move back to an obstructing locations. Thus, part of the light emitted by the lamp 13 and reflected by the reflecting surface 12 will be blocked off by the two light shields 3, 3′ and impossible to be projected out completely, letting light project out only through an upper uncovered portion of the two light shields 3, 3′ and thus attaining a lighting condition of low beam.

To sum up, the control device of a headlamp's high and low beam in the present invention is to have two drivers 2, 2′ driving the two light shields 3, 3′ to carry out relative operation for controlling a light projecting range of the headlamp. By so designing, it is needless to turn the lamp base 1 for achieving effect of change-over of high and low beam, able to prolong service life of headlamps.

While the preferred embodiment of the invention has been described above, it will be recognized and understood that various modifications may be made therein and the appended claims are intended to cover all such modifications that may fall within the spirit and scope of the invention.

What is claimed is:

1. A control device of a headlamp's high and low beam comprising:
a lamp base having a periphery formed with a projecting edge, said lamp base having an interior provided with an arc-shaped reflecting surface and a lamp;
two drivers oppositely installed at two outer sides of said lamp base, said two drivers respectively provided with a driving shaft; and
two light shields respectively assembled on said two drivers, said two light shields respectively and oppositely bored with a through hole at an outer side for said driving shaft to be inserted therethrough, said two light shields having opposite inner sides superposed on each other, said two light shields respectively positioned under a front side of said lamp base.

2. The control device of a headlamp's high and low beam as claimed in claim 1, wherein said lamp base oppositely provided with two projecting bars respectively for supporting said two light shields.

3. The control device of a headlamp's high and low beam as claimed in claim 1, wherein said driving shaft of each said driver has an outer end oppositely provided with a tangent plane, said through hole of each said light shield having a same shape as an outer end of each said driving shaft, each said driving shaft having a top end bored with a threaded hole, a fastening element respectively inserted through said through hole of said two light shields and threadably secured in said threaded hole of each said driving shaft.
